(19) United States
(12) Patent Application Publication
(10) Pub. No.: US 2006/0043640 A1
(43) Pub. Date: Mar. 2, 2006

(54) Method and system for multi-stage injection in a transfer molding system

(75) Inventors: Syed O.S. Mahmood, Taman Bukit Utama (MY); Azman F. Aminuddin, Subang Jaya (MY); Jeremy J. Sammy, Subang Jaya (MY)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/924,583

(22) Filed: Aug. 24, 2004

(51) Int. Cl. B29C 70/70; B29C 70/88; B29C 45/02

(52) U.S. Cl. 264/272.17; 264/328.1; 425/129.1

(57) ABSTRACT

A system and method for multi-stage injection in a transfer molding system. Some exemplary embodiments may be a method used in a transfer molding system comprising compressing a molding compound, injecting a center portion of the compressed molding compound into a mold, and then injecting an outer portion of the compressed molding compound into the mold.

### BACKGROUND

1. Technical Field

The present subject matter relates to packaged semiconductor devices manufactured by a transfer molding system. More particularly, the subject matter relates to using a multi-stage plunger to reduce the occurrence of voids within packaged semiconductor devices manufactured by a transfer molding system.

2. Background

Semiconductor devices may be fabricated on the surface of a semiconductor wafer in layers and later cut into individual dies. Since the material of a semiconductor wafer (e.g., silicon) tends to be relatively fragile and brittle, dies are often assembled into a protective housing, or package, before they are interconnected with a printed circuit board. These assembled dies and their surrounding packages may be referred to as “packaged semiconductor devices.”

One system that may be used to create at least a portion of a package is a transfer molding system. Referring to FIGS. 1 and 1A, dies are mounted and connected to individual lead frames, and the assembled dies and lead frames 116 are in turn placed into the cavities 122 within the mold 105. A heated molding compound (e.g., plastic) is injected under pressure by plunger 114 through pot bushing 112 into the mold 105. The heated molding compound is guided by the cull and runner system 124 to the cavities 122. When the heated molding compound reaches the cavities 122 it surrounds the dies and lead frames 116, encapsulating them while taking on the shape of the mold 105. Once the molding compound has hardened, the mold 105 is opened and the packages are removed. Excess material is trimmed and the leads are cut and formed into their final shapes.

One step in this type of package manufacturing is the removal of air from the molding compound prior to injection into the mold. If air is trapped within the molding compound it may result in voids within the packaged semiconductor devices. These voids are undesirable since they increase the probability of the failure of the device due to a variety of failure mechanisms (e.g., uneven thermal stress, oxidation due to the trapped air, and leaching of contaminants from the trapped air into the semiconductor die). Such failures can have an adverse effect on the number of good finished production units (sometimes referred to as the production “yield”).

As shown in FIG. 2, air may become trapped along the sides of the molding compound 205 as it is injected into the mold 105. The entrapped air 215 may then be pushed into the interior mold 105 and may result in voids within the finished packages. One technique for reducing the amount of entrapped air 215 along the sides is to unevenly heat the molding compound 205 as shown in FIG. 3. When the center portion “B” is heated to a temperature higher than the ends “A”, and the molding compound 205 is compressed as shown, the molding compound 205 deforms into a “beer-barrel” shape. As shown in FIG. 4, this shape causes the air to collect in two locations, one at the top of the molding compound near the plunger (entrapped air 435), and one at the bottom within the molding compound (air 445). When the molding compound 205 is pushed into the mold 105, the air 445 initially at the bottom of the molding compound 205 is pushed out the ends of the mold 105, while the entrapped air 435 initially at the top of the molding compound 205 remains within the cull and runner system 124 of the mold 105.

Small amounts of air may still be trapped within the filler material used to manufacture the molding compound 205 in spite of these techniques. The size of these air pockets may be well below the reject criteria for voids within the packaged semiconductor device. If the temperature differential used to produce the beer-barrel shape of the molding compound 205 is not setup correctly, or the temperature of the molding compound 205 is not kept stable, these small individual air pockets within the filler may merge (illustrated as entrapped air 525 in FIGS. 5A through 5C). This may result in the formation of voids large enough to exceed the reject criteria, which can again cause a reduced production yield if the voids reach the packaged semiconductor device within the mold 105.

Accordingly, a molding system capable of isolating voids formed by incorrect setup or unstable heating of the molding compound, and capable of reducing the introduction of such voids into the packaged semiconductor device is desirable.

### SUMMARY OF SOME OF THE EMBODIMENTS

The problems noted above are addressed in large part by a system and method for multi-stage injection in a transfer molding system. Some exemplary embodiments may be a method used in a transfer molding system comprising compressing a molding compound, injecting a center portion of the compressed molding compound into a mold, and then injecting an outer portion of the compressed molding compound into the mold.

Other exemplary embodiments may be a transfer molding system comprising a mold and a plunger, the plunger comprising an inner sub-plunger concentrically disposed within an outer sub-plunger. The inner sub-plunger injects an inner region of a heated molding compound into the mold. The outer sub-plunger then injects an outer region of the heated molding compound into the mold.

### BRIEF DESCRIPTION OF THE DRAWINGS

For a detailed description of the embodiments of the invention, reference will now be made to the accompanying drawings in which:

FIG. 1 illustrates a transfer molding system;

FIG. 1A illustrates a detailed view of a die mounted on a lead frame;

FIG. 2 illustrates the formation of air pockets within a transfer molding system;

FIG. 3 illustrates the “beer-barrel effect”;

FIG. 4 illustrates the use of the “beer-barrel effect” to control the location of entrapped air;

FIGS. 5A through 5C illustrate the formation of air pockets within a transfer molding system utilizing the “beer-barrel effect”;

FIG. 6 illustrates a transfer molding system constructed in accordance with at least some embodiments of the invention;

FIGS. 7A and 7B illustrate a multi-stage plunger constructed in accordance with at least some embodiments of the invention;

FIGS. 8A through 8C illustrates operation of a multi-stage plunger within a transfer molding system constructed in accordance with at least some embodiments of the invention; and

FIG. 9 illustrates a method of injecting a molding compound into a transfer molding system in multiple stages, in accordance with at least some embodiments of the invention.

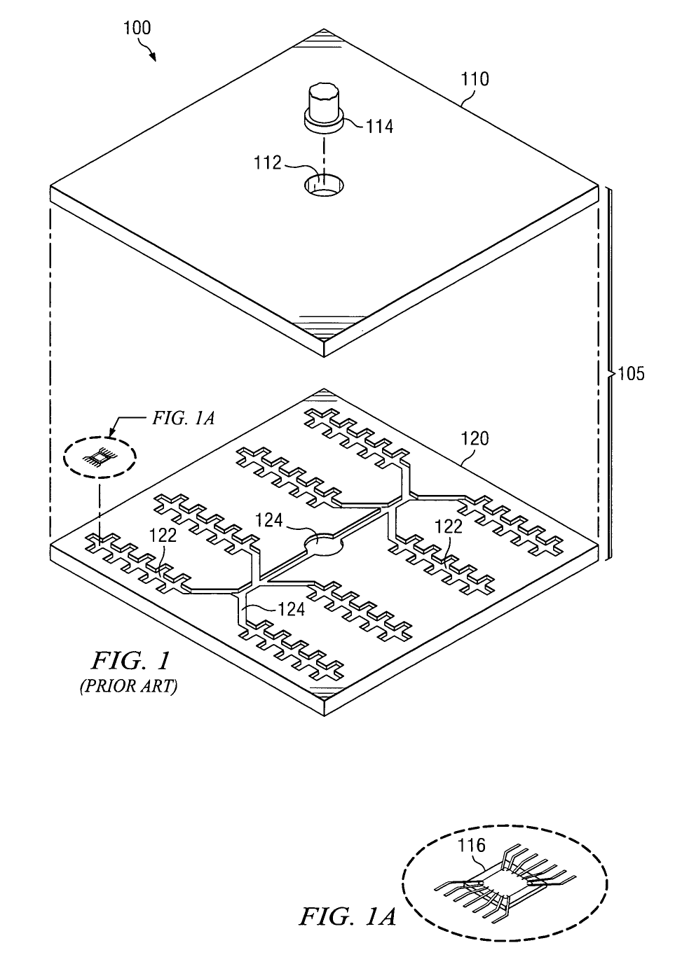

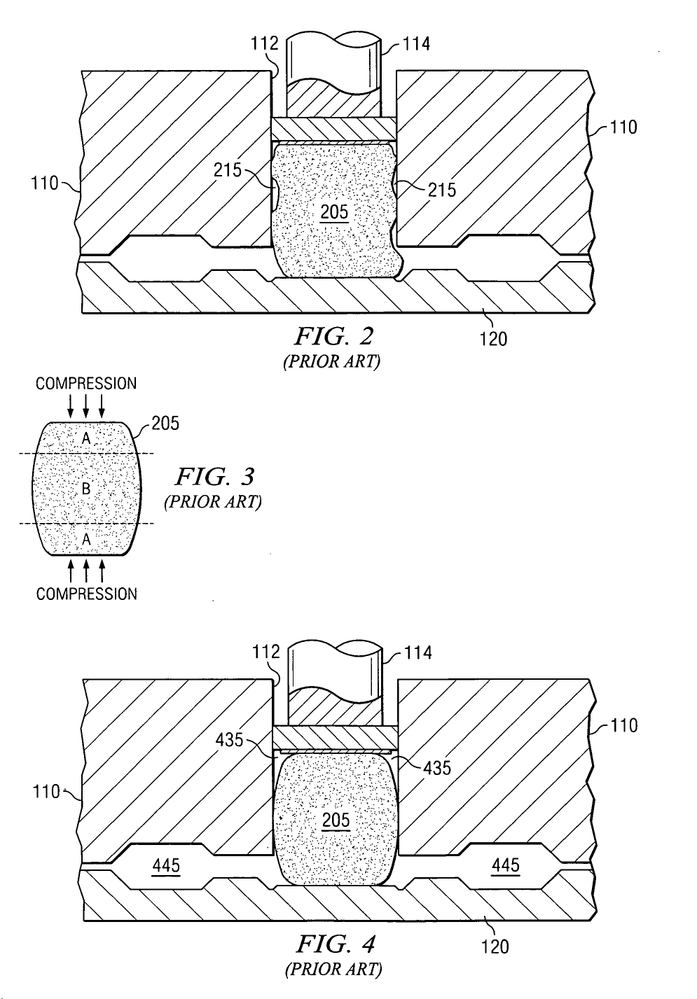

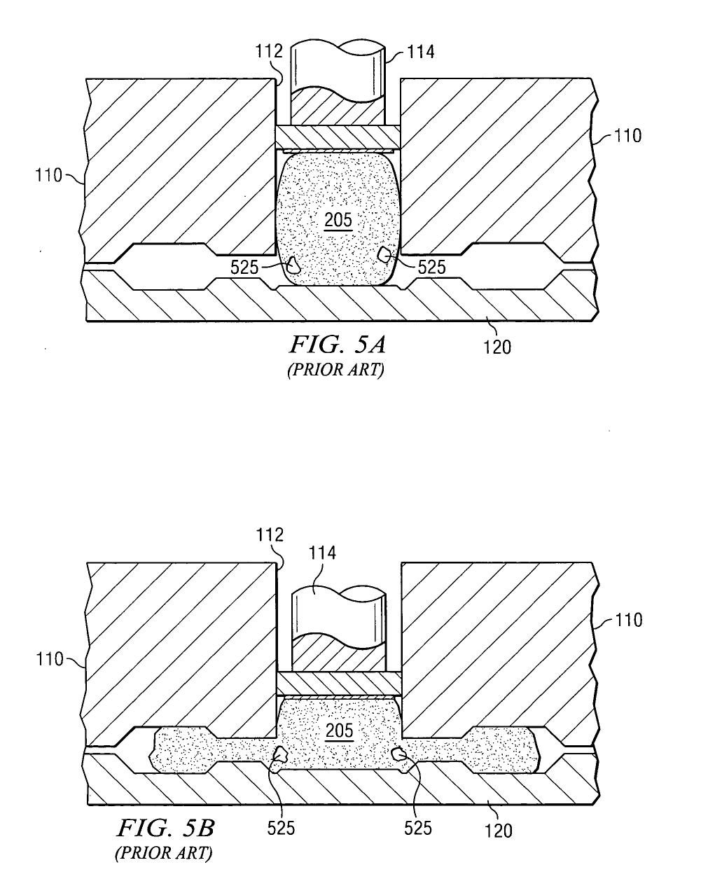

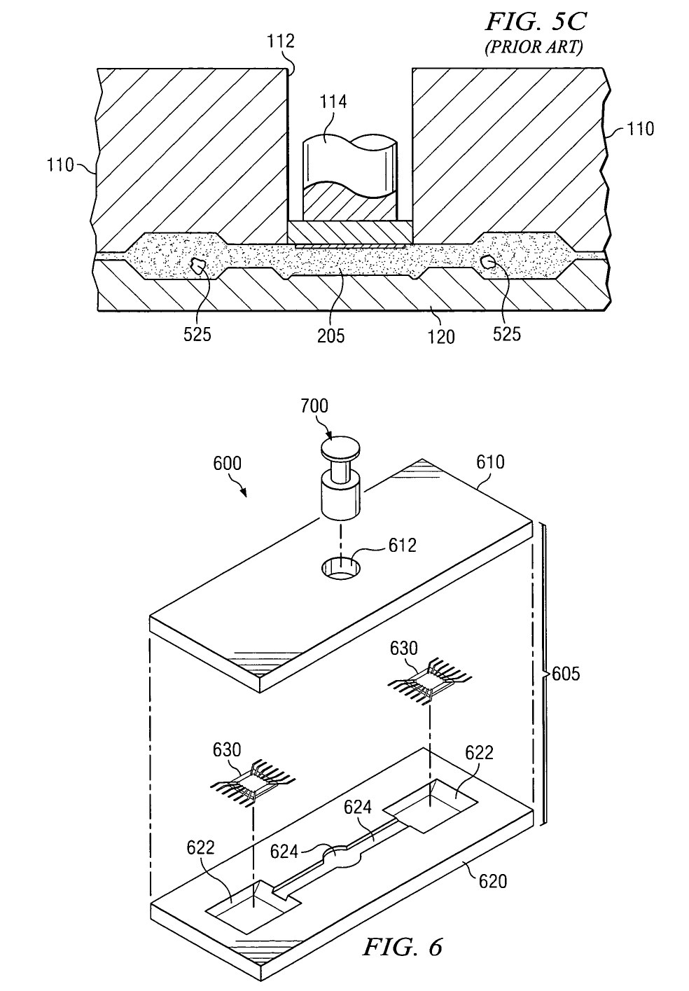

### NOTATION AND NOMENCLATURE

Certain terms are used throughout the following discussion and claims to refer to particular system components. This document does not intend to distinguish between components that differ in name but not function. In the following discussion and in the claims, the terms “including” and “comprising” are used in an open-ended fashion, and thus should be interpreted to mean “including but not limited to . . . . ” Also, the term “couple” or “couples” is intended to mean either an indirect or direct electrical or mechanical connection. Thus, if a first device couples to a second device, that connection may be through a direct electrical or mechanical connection, or through an indirect electrical or mechanical connection via other devices and connections. To the extent that any term is not specifically defined in this specification, the intent is that the term is to be given its plain and ordinary meaning.

### DETAILED DESCRIPTION OF THE EMBODIMENTS

The following is a description of the various embodiments of the invention in the context of the manufacturing of a packaged semiconductor device. However, it should be noted that the principles described herein are not limited to just the manufacturing of packaged semiconductor devices. The apparatus and methods described herein can be applied to numerous other types of devices encapsulated in a sealed package and manufactured at least in part using a transfer molding system.

FIG. 6 illustrates a transfer molding system 600 used to manufacture the types of packages that encapsulate many semiconductor devices and constructed in accordance with at least some embodiments of the invention. Semiconductor dies and lead frames 630 are placed in cavities 622 prior to injection of a molding compound. The molding compound (e.g., plastic) is heated and injected through the pot bushing 612 by the multi-stage plunger 700. The heated molding compound is routed to the cavities 622 by the cull and runner system 624 of the transfer molding system 600. The injected molding compound encapsulates the semiconductor dies and lead frames 630 within the cavities 622, forming sealed packages around the semiconductor dies and the lead frames.

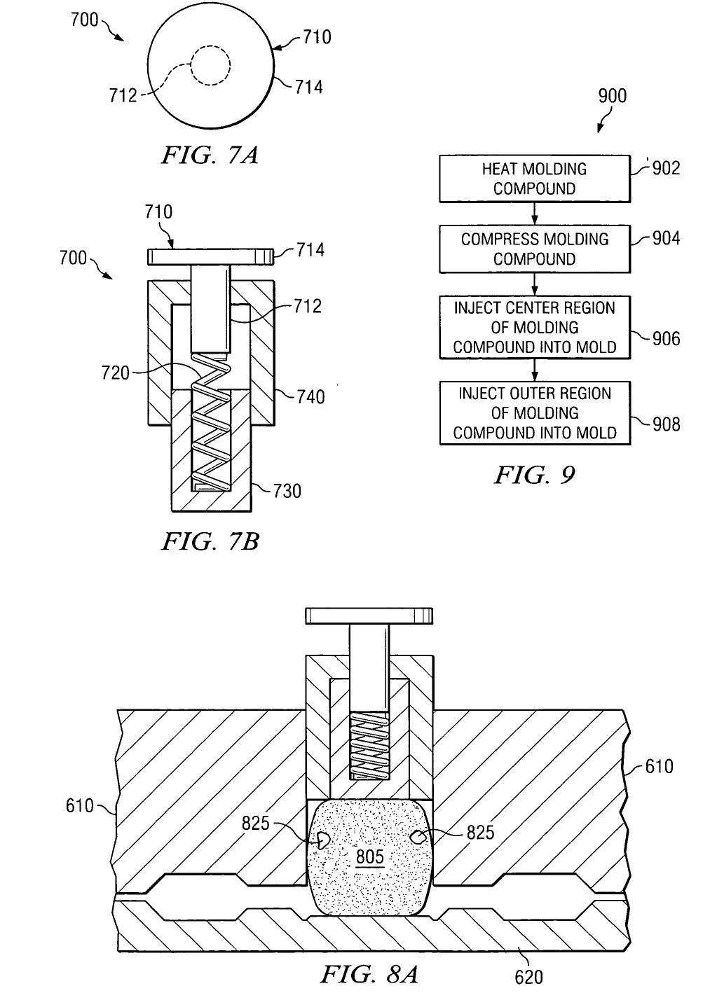

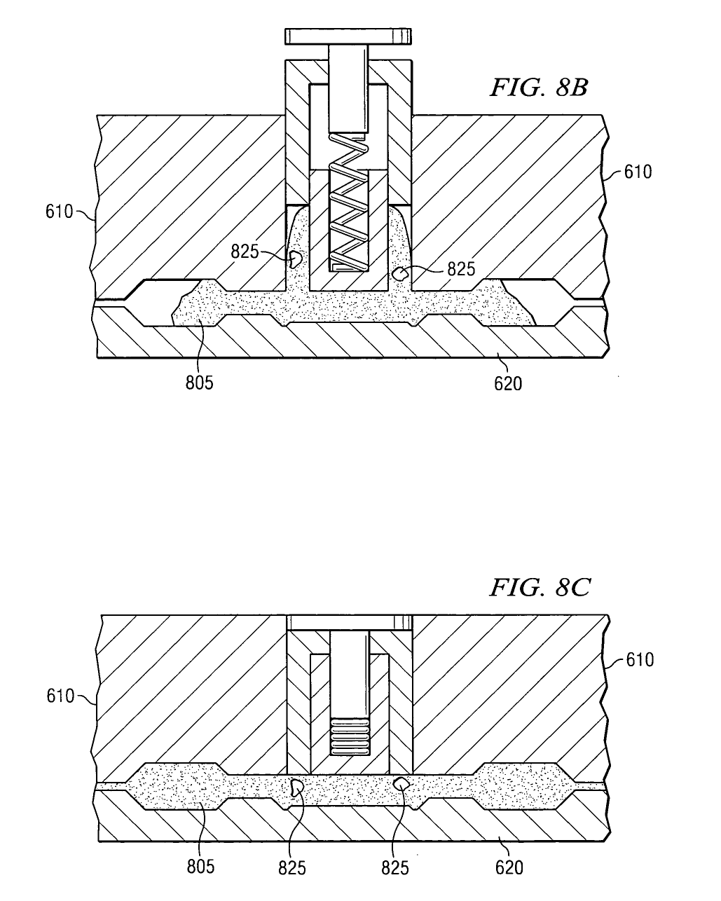

FIGS. 7A and 7B illustrate a multi-stage plunger 700 constructed in accordance with at least some embodiments of the invention that addresses the problem of introducing entrapped air into a finished molded package. Although a cylindrical multi-stage plunger is illustrated, the multi-stage plunger 700 is not limited to embodiments that incorporate geometries with circular cross-sections. The multi-stage plunger may comprise an actuator 710, a spring 720, an inner plunger 730 and an outer plunger 740. The actuator 710 may couple to the spring 720, which in turn may couple to the inner plunger 730. In accordance with at least some embodiments the actuator 710 may be constructed with a circular actuator head 714 and a smaller circular actuator stem 712. When force is initially applied to the actuator head 714, the actuator stem 712 (which passes through an opening at the top of the outer plunger 740) transfers the applied force to the inner plunger 730 through the spring 720. This causes the inner plunger 730 to actuate before the outer plunger 740, injecting an inner region of the molding compound 805 into the mold 605 first, as shown in FIGS. 8A through 8C.

Continuing to refer FIGS. 8A through 8C, when the inner plunger 730 reaches the end of its travel, the actuator head 714 contacts the top of the outer plunger 740. The force applied to the actuator head 714 is thus transferred to the outer plunger 740, which causes the outer plunger 740 to inject the remaining outer region of the molding compound 805 into the mold 605. Because this outer region of the molding compound 805 is injected into the mold 605 last, the entrapped air 825, which accumulates in the outer edge of the molding compound, is also injected into the mold 605 last. The entrapped air 825 thus may not reach a finished molded package, ending up instead within the cull and runner system 624. The portion of the cured molding compound 805 with the entrapped air 825 is subsequently removed as excess from the finished molded package.

FIG. 9 illustrates a method 900 for a multi-stage injection of a molding compound into the transfer molding system 600. The method 900, in accordance with at least some embodiments of the invention, may begin by heating the molding compound (block 902). The molding compound may be heated unevenly so as to produce a beer-barrel shaped cylinder. The heating softens the molding compound such that it may be compressed as indicated in block 904. The heated, compressed molding compound may then be injected into the transfer molding system 600 in two stages. In the first stage, a center cylindrical region may be injected into the transfer molding system 600 (block 906). This region contains fewer and smaller air pockets and is the portion of the molding compound preferred in forming the semiconductor packages.

In the second stage, an outer cylindrical region may be injected into the transfer molding system 600 (block 908). This region contains a greater number of larger air pockets and is less desirable in forming the semiconductor packages. By injecting the outer cylindrical region after the center cylindrical region, the molding compound of the outer cylindrical region serves to push the molding compound from the center cylindrical region through the cull and runner system 624 and into the cavities 622 of the transfer molding system 600 (see FIG. 6), where it forms the semiconductor packages. The molding compound from the outer cylindrical region most likely does not reach the cavities 622, ending up instead within the cull and runner system 624, where it is later trimmed away from the finished semiconductor packages as excess material.

The above disclosure is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method used in a transfer molding system, comprising:
compressing a molding compound, said molding compound usable to encapsulate a semiconductor device;
injecting a center portion of the compressed molding compound into a mold; and then
injecting an outer portion of the compressed molding compound into the mold.

2. The method of claim 1, further comprising heating the molding compound.

3. The method of claim 2, further comprising heating a region midway along a line of compression of the molding compound to a temperature higher than regions at either end of the compound along the line of compression.

4. The method of claim 1, wherein the molding compound is injected into the mold by a plunger comprising an inner sub-plunger and a concentrically mounted outer sub-plunger.

5. The method of claim 4, wherein the plunger has a circular cross-section perpendicular to a line of compression of the molding compound.

6. A transfer molding system, comprising:
a mold; and
a plunger comprising an inner sub-plunger telescopically disposed within an outer sub-plunger;
wherein the inner sub-plunger injects an inner region of a heated molding compound into the mold; and
wherein the outer sub-plunger then injects an outer region of the heated molding compound into the mold.

7. The transfer molding system of claim 6, further comprising:
a heater that heats the molding compound unevenly;
wherein the molding compound deforms unevenly when heated, the molding compound bulging at substantially a midpoint of a line of compression of the plunger.

8. The transfer molding system of claim 6, wherein the molding compound is used to encapsulate a semiconductor device.

9. The transfer molding system of claim 6, wherein the plunger has a circular cross-section perpendicular to a line of compression of the plunger.

10. A transfer molding system, comprising:
means for molding; and
means for injecting comprising an inner means for injecting concentrically positioned within an outer means for injecting;
wherein the inner means for injecting injects an inner region of a heated molding compound into the means for molding; and
wherein the outer means for injecting then injects an outer region of the heated molding compound into the means for molding.

11. The transfer molding system of claim 10, further comprising:
means for heating that heats the molding compound unevenly;
wherein the molding compound deforms unevenly when heated by the means for heating, the molding compound bulging at substantially a midpoint of a line of compression of the means for injecting.

12. The transfer molding system of claim 10, wherein the means for molding shapes the molding compound to encapsulate a semiconductor device.

13. The transfer molding system of claim 10, wherein the means for injecting has a circular cross-section perpendicular to a line of compression of the means for injecting.

14. The transfer molding system of claim 10, wherein the means for injecting comprises a plunger, said plunger comprising an inner sub-plunger telescopically disposed within an outer sub-plunger.
